(19) United States
(12) Patent Application Publication
(10) Pub. No.: US 2021/0157211 A1
(43) Pub. Date: May 27, 2021

(54) INTERFEROMETRIC MODULATION

(71) Applicant: Lightmatter, Inc., Boston, MA (US)

(72) Inventors: Nicholas C. Harris, Jamaica Plain, MA (US); Michael Gould, Boston, MA (US); Mykhailo Tymchenko, Malden, MA (US); Weilu Gao, Cambridge, MA (US); Shashank Gupta, Newton, MA (US)

(73) Assignee: Lightmatter, Inc., Boston, MA (US)

(21) Appl. No.: 16/952,488

(22) Filed: Nov. 19, 2020

Related U.S. Application Data
(60) Provisional application No. 62/938,576, filed on Nov. 21, 2019.

(51) Int. Cl. G02F 1/225; G02B 27/10

(52) U.S. Cl. CPC G02F 1/225; G02F 2001/212; G02B 27/1006

(57) ABSTRACT

The techniques described herein relate to methods and apparatus for interferometric modulation. An apparatus includes an interferometric device comprising a first optical path and a second optical path, and at least one Franz-Keldysh (FK) modulator disposed in either the first optical path or the second optical path of the interferometric device. The interferometric device receives input light, wherein a first portion of the input light travels along the first optical path of the interferometric device, and a second portion of the input light travels along the second optical path of the interferometric device. The FK modulator modulates an intensity of either the first portion of the input light or the second portion of the input light.

### RELATED APPLICATIONS

This application is a Non-Provisional of and claims priority under 35 U.S.C. § 119 (e) to U.S. Application Ser. No. 62/938,576, filed Nov. 21, 2019, entitled “INTERFEROMETRIC MODULATION VIA THE FRANZ-KELDYSH EFFECT,” which is incorporated by reference herein in its entirety.

### FIELD

This application relates generally to interferometric modulation, including interferometric modulation via the Franz-Keldysh effect.

### BACKGROUND

Interferometers generally leverage interference caused by the combination of multiple light rays to extract information. In some interferometers, a light travels along different optical paths that are combined to produce the interference. Interferometers can be used across a myriad of industries and applications, and therefore have wide applicability.

### SUMMARY

According to one aspect, an apparatus is provided. The apparatus includes an interferometric device including a first optical path and a second optical path, and at least one Franz-Keldysh (FK) modulator disposed in either the first optical path or the second optical path of the interferometric device.

In some examples, the interferometric device comprises a Mach-Zehnder interferometer.

In some examples, the at least one FK modulator comprises a first FK modulator and a second FK modulator. The first FK modulator can be disposed in the first optical path of the interferometric device, and the second FK modulator can be disposed in the second optical path of the interferometric device. The first FK modulator can include a first set of electrodes, the second FK modulator can include a second set of electrodes, a first electrode of the first set of electrodes of the first FK modulator can be in electrical communication with a full voltage driving source, and a second electrode of the second set of electrodes of the second FK modulator is in electrical communication with a control driving source. A third electrode of the first set of electrodes of the first FK modulator can be in electrical communication with a ground, and a fourth electrode of the second set of electrodes of the second FK modulator can be in electrical communication with the ground. A first phase shifter can be disposed in the first optical path, a second phase shifter can be disposed in the second optical path, or both. The first phase shifter, the second phase shifter, or both, can be a pi phase shifter.

In some examples, the interferometric device includes an optical input, a first optical output, and a second optical output. The device also includes a first beam splitter in optical communication with the optical input, the first optical path, and the second optical path, and a second beam splitter in optical communication with the first optical path, the second optical path, the first optical output, and the second optical output. The interferometric device can further include a first detector in optical communication with the first optical output, and a second detector in optical communication with the second optical output.

In some examples, the at least one FK modulator includes a waveguide comprising a proximal end for receiving light, a distal end for emitting light, and an outer perimeter extending between the proximal end and the distal end along an optical path of the waveguide. The FK modulator can also include a pair of electrodes disposed on opposite sides of the optical path of the waveguide, such that the pair of electrodes can apply an electric field in a direction across to the optical path.

According to one aspect, a method is provided. An interferometric device receives input light, wherein a first portion of the input light travels along a first optical path of the interferometric device, and a second portion of the input light travels along a second optical path of the interferometric device. The method includes modulating, by at least one Franz-Keldysh (FK) modulator disposed in either the first optical path or the second optical path of the interferometric device, an intensity of either the first portion of the input light or the second portion of the input light.

In some examples, the at least one FK modulator includes a first FK modulator and a second FK modulator, wherein the first FK modulator is disposed in the first optical path of the interferometric device, and the second FK modulator is disposed in the second optical path of the interferometric device, and modulating the intensity of the first portion of the input light or the second portion of the input light includes modulating a first intensity of the first portion of the input light traveling along the first optical path to generate a modulated first portion of light, and modulating a second intensity of the second portion of the input light traveling along the second optical path to generate a modulated second portion of light. A full driving voltage can be applied to a first electrode of a first set of electrodes of the first FK modulator, and a control voltage can be applied to a second electrode of a second set of electrodes of the second FK modulator. A phase of the modulated first portion of light traveling along the first optical path can be shifted by a first phase shifted disposed in the first optical path, a phase of the modulated second portion of light traveling along the second optical path can be shifted by a second phase shifter disposed in the second optical path, or both.

In some examples, receiving the input light includes receiving the input light through an optical input of the interferometric device, and the method further includes splitting the input light, using a first beam splitter in optical communication with the optical input, the first optical path, and the second optical path, into the first portion of the input light that travels along the first optical path and the second portion of the input light that travels along the second path. The method can further include splitting the first portion of the input light and the second portion of the input light, using a second beam splitter in optical communication with the first optical path and the second optical path, into a third portion of light that travels through a first optical output of the interferometric device, and a fourth portion of light that travels through a second optical output of the interferometric device. The method can further include detecting, via a first detector in optical communication with the first optical output, the third portion of light, and detecting, via a second detector in optical communication with the second optical output, the fourth portion of light.

In some examples, the light is electromagnetic radiation. The electromagnetic radiation can be visible light, infrared light, ultraviolet light, x-ray light, or some combination thereof.

According to one aspect, a method of manufacturing an interferometric device is provided. The method includes forming a first optical path and a second optical path of the interferometric device, and forming at least one Franz-Keldysh (FK) modulator disposed in either the first optical path or the second optical path of the interferometric device.

In some examples, forming the at least one FK modulator includes forming a first FK modulator disposed in the first optical path of the interferometric device, and forming a second FK modulator disposed in the second optical path of the interferometric device. A phase shifter can be formed on one of the optical paths between one of the FK modulators and an output of the interferometric device.

### BRIEF DESCRIPTION OF THE DRAWINGS

Various aspects and embodiments will be described herein with reference to the following figures. It should be appreciated that the figures are not necessarily drawn to scale. Items appearing in multiple figures are indicated by the same or a similar reference number in all the figures in which they appear.

FIG. 1 is an exemplary diagram showing a configuration of an interferometer with two modulators, according to some embodiments.

FIG. 2 is a schematic diagram of an illustrative circuit, according to some embodiments.

FIG. 3 is a flow chart illustrating the exemplary operation of an interferometric device, according to some embodiments.

FIG. 4 shows two graphs illustrating the operational characteristics of an interferometric device, according to some embodiments.

FIG. 5 shows a block diagram of an example computer system that may be used to implement embodiments of the technology described herein.

### DETAILED DESCRIPTION

The Franz-Keldysh (FK) effect is an electro-optic effect in semiconductors wherein the band-structure of a semiconductor is altered by an electric field. This band-structure modification changes the optical properties of the material, particularly at photon energies near the bandgap. The FK effect can be used to build electro-absorption modulators, which are semiconductor devices that can change the optical absorption of a material using a voltage. Electro-absorption modulators can include a waveguide with electrodes that are used to apply an electric field in a direction that is across the modulated light beam. Compared with other types of modulators, such as electro-optic modulators, electro-absorption modulators can operate with lower voltages. Electro-absorption modulators can operate at high speed, and can achieve high bandwidth (e.g., tens of gigahertz).

The inventors have discovered and appreciated that FK modulators typically suffer from a fundamental tradeoff between extinction ratio and insertion loss. The extinction ratio of a modulator refers to the ratio of two optical power levels, such as the optical power at maximum transmission and the optical power at minimum transmission of an optical source (e.g., a laser diode). For example, the extinction ratio can refer to the ratio of the output powers for the 1 and 0 bits of a digital signal generated by an optical source. The insertion loss refers to the loss of signal power resulting from the insertion of a device in a transmission line or optical fiber (e.g., in dB). It can therefore be desirable to have a high extinction ratio and a low insertion loss. However, FK modulators can typically be configured with either a poor extinction ratio and low loss, or a large extinction ratio and high loss, but not both low loss and a high extension ratio. This has led to designing systems that operate according to either low-loss or a high extinction ratio, but not both.

To address the above-described shortcomings of conventional systems, the inventors have developed a modulator that can make use of both the change in absorption and the change in refractive index associated with the FK effect. In some embodiments, such a modulator is achieved by using one or more FK modulators in an interferometric device. The FK modulators can be used to generate the phase shift in an interferometric device (e.g., in place of junctions). In particular, the inventors have discovered and appreciated that by using FK modulators in an interferometric device, a high extinction ratio can be obtained with low insertion-loss by using the FK effect.

In some embodiments, the interferometric device is a Mach-Zehnder interferometer (MZI). MZIs can be used in various types of applications such as, for example, in integrated optical circuits. The optical wavelengths used by integrated optical circuits can be, for example, in the visible spectrum (e.g., 400 to 700 nm) and/or near infrared (e.g., 850 nm to 1650 nm). However, the techniques described herein are not so limited and can be used for any electromagnetic radiation, including ultraviolet light (e.g., 10-400 nm), X-rays, and/or the like. MZIs can be used to implement various devices, including modulators (e.g., electro-optic modulators, such as RF modulators), sensors, optical switches, and/or the like. MZIs can provide high-bandwidth electro-optic amplitude and phase responses over a large frequency range.

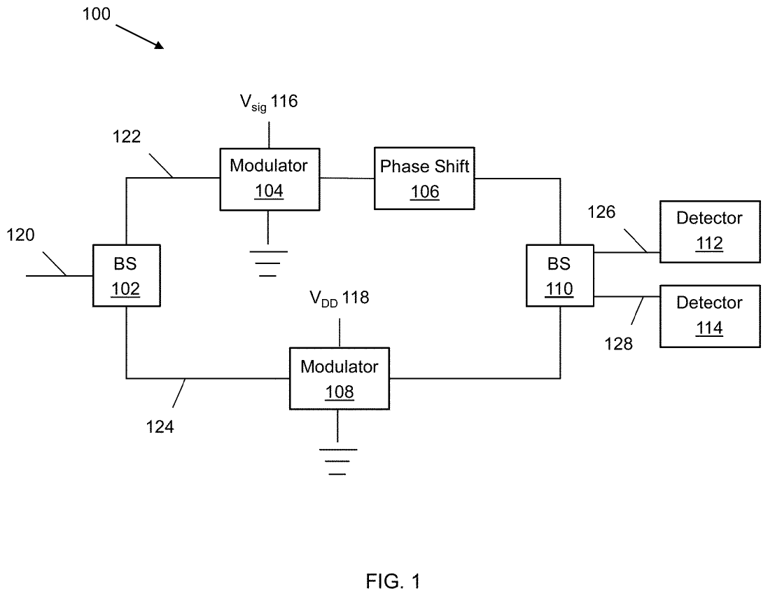

In some embodiments, the interferometric device includes two optical paths, and at least one modulator (e.g., FK modulator) that is disposed in at least one of the optical paths of the interferometric device. In some embodiments, the interferometric device can include a modulator in each optical path. FIG. 1 is an exemplary diagram showing a configuration of an interferometric device 100 with two modulators 104 and 108, according to some embodiments. The interferometric device 100 includes beam splitter 102 that splits input optical path 120 into first optical path 122 and second optical path 124. Thus, beam splitter 102 is in optical communication with optical input 120, first optical path 122, and second optical path 124. Modulator 104 is disposed in first optical path 122 of the interferometric device 100, and modulator 108 is disposed in second optical path 124 of the interferometric device 100. Modulator 108 has a full driving voltage V_{DD} 118 applied to a first electrode of modulator 108, and the other electrode is connected to ground. Modulator 104 has a control driving source, signal V_{sig} 116, applied to a first electrode of modulator 104, and the other electrode is connected to ground. In this example, a phase shift 106 (e.g., a static pi-phase shift) is applied after modulator 104. While not shown, in some embodiments, a second phase shift can be applied after modulator 108, either as the sole phase shift in the interferometric device 100 and/or as a second phase shift with phase shift 106. When V_{sig} 116 is set equal to V_{DD} 118, the transmission is approximately zero. When V_{sig} 116 is set to approximately 0 volts, the difference in phase and amplitude between modulators 104 and 108 leads to a non-zero transmission.

Optical paths 122 and 124 enter beam splitter 110, which results in optical output 126 and optical output 128. Thus, beam splitter 110 is in optical communication with optical path 122, optical path 124, optical output 126, and optical output 128. Detector 112 is in optical communication with optical output 126, and detector 114 is in optical communication with optical output 128. Equation 1 below can be used to model the operation of the exemplary circuit described for the interferometric device 100:

$${P}_{out} ( {V}_{sig} ) / {P}_{in} = \frac{{\vert {e}^{j \frac{2 }{λ} N ( {V}_{sig} )} - {e}^{j \frac{2 }{λ} N ( {V}_{DD} )} \vert}^{2}}{4} \qquad ( Equation 1 )$$

Where:
Pₒᵤₜ(V_{sig}) is the output power at a driving voltage V_{sig};
Pᵢₙ is the input power;
N(V_{sig}) and N(V_{DD}) are complex refractive indices of modulators on the two different optical paths (or arms) at driving voltages V_{sig} and V_{DD}, respectively.

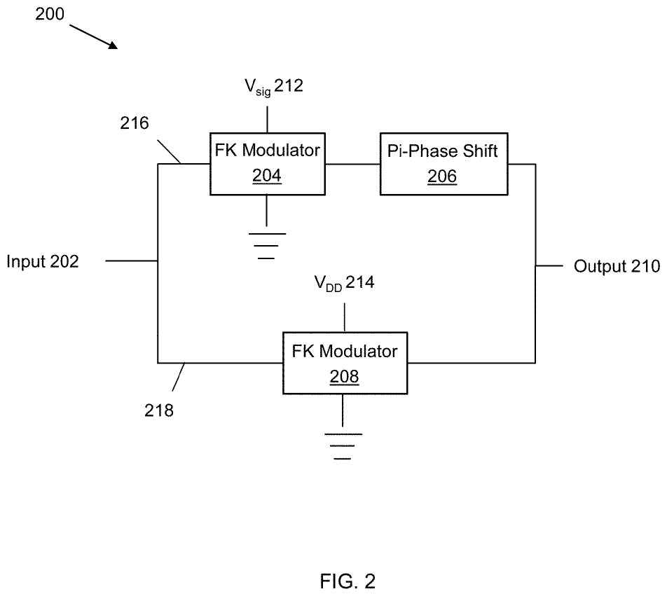

FIG. 2 is a schematic diagram of an illustrative circuit 200, according to some embodiments. The circuit 200 includes an input optical path 202 that splits into first optical path 216 and second optical path 218. FK modulator 204 is disposed in first optical path 216, and FK modulator 208 is disposed in second optical path 218. FK modulator 208 has a full driving voltage V_{DD} 214 applied to a first electrode of FK modulator 208, and the other electrode is connected to ground. FK modulator 204 has a control driving source, signal V_{sig} 212, applied to a first electrode of FK modulator 204, and the other electrode is connected to ground. Pi-phase shifter 206 is disposed after FK modulator 204 (although while not shown, it should be appreciated that a pi-phase shift could be disposed after FK modulator 208 and/or in both locations). The optical signals from paths 216 and 218 are combined into optical output 210.

As described herein, each FK modulator can include a waveguide. In some embodiments, the waveguide can be formed and/or made of a dedicated material used for the waveguide (e.g., such that the waveguide is deposited into a portion of a semiconductor chip or device). In some embodiments, the waveguide is a portion of an existing layer and/or component of a semiconductor chip or device. The waveguide can generally have two ends along the direction that light travels: a proximal end for receiving light, a distal end for emitting light. The waveguide can have an outer area or perimeter that extends between the proximal end and the distal end, and around the optical path of the waveguide. The FK modulator can have a set of electrodes that are used to apply an electric field to the waveguide. For example, the FK modulator can include a pair of electrodes that are disposed on opposite sides of the optical path of the waveguide (e.g., on separate sides of the outer area/perimeter of the waveguide), such that the pair of electrodes can apply an electric field in a direction that is across the optical path of the waveguide. For example, the direction can be perpendicular to the optical path of the waveguide, but the direction is not limited as such.

The techniques described herein include techniques for manufacturing components, such as semiconductor components, according to the techniques described herein. For example, an interferometric device can be manufactured by forming a first optical path and a second optical path of the interferometric device, and forming at least one FK modulator that is disposed in either the first optical path or the second optical path of the interferometric device. As described herein, the manufacturing method can include forming a first FK modulator disposed in the first optical path of the interferometric device and forming a second FK modulator disposed in the second optical path of the interferometric device. The techniques can include forming a phase shifter between one of the FK modulators and an output of the interferometric device.

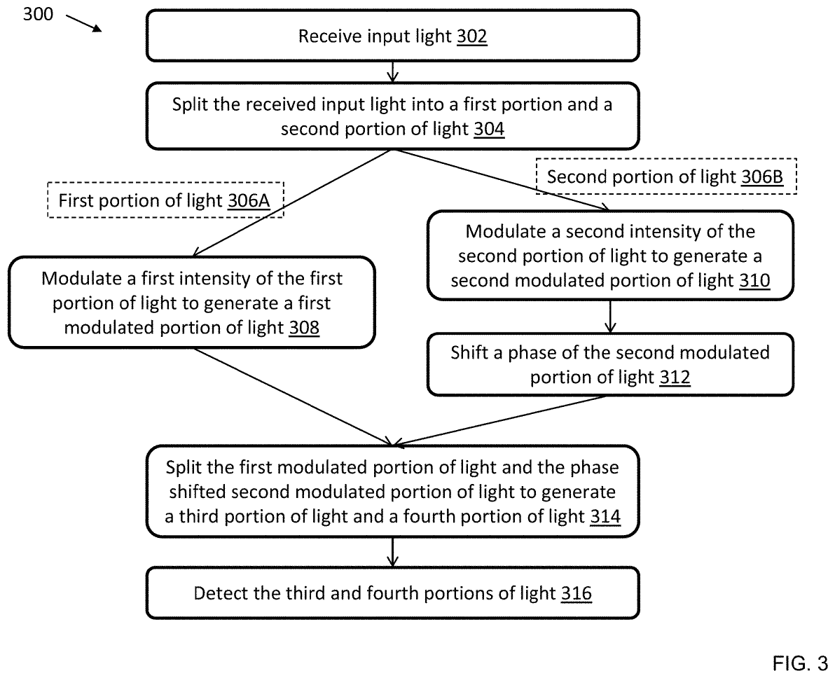

As described herein, light in at least one optical path of an interferometric device is modulated by a modulator, such as an FK modulator, in order to modulate the intensity of the light. FIG. 3 is a flow chart 300 illustrating the exemplary operation of an interferometric device, according to some embodiments. The interferometric device can be implemented according to aspects of the techniques described in conjunction with FIG. 1 and/or FIG. 2, for example. The flow chart 300 describes an example of an interferometric device with two modulators, although as described herein the techniques are not limited to interferometric devices with two modulators. At step 302, the interferometric device receives input light. At step 304, the interferometric device splits the input light (e.g., via a beam splitter) into a first portion of light 306A and a second portion of light 306B. The first portion 306A travels along a first optical path of the interferometric device, and the second portion 306B travels along the second optical path of the interferometric device.

At step 308, a first modulator disposed in the first optical path modulates the intensity of the first portion of the input light 306A traveling along the first optical path to generate a modulated first portion of light. At step 310, a second modulator disposed in the second optical path modulates the intensity of the second portion of the input light 306B traveling along the second optical path to generate a modulated second portion of light. At step 312, a phase shifter disposed in the second optical path shifts the phase of the modulated second portion of light to generate a modulated and phase shifted second portion of light. Each modulator can include a pair of electrodes disposed on opposite sides of the waveguide, such that the modulator applies an electric field orthogonal to the direction of light travel. As described herein, different voltages can be applied to the modulators of the interferometric device. A full driving voltage can be applied to the first modulator, and a different control voltage can be applied to the second modulator. The control voltage can be different than the full driving voltage, which will generate a phase shift (which the interferometer can convert to an amplitude, as described herein). The full driving voltage can be a constant voltage that does not change over time. For example, the full driving voltage can be 0.5 volts, 1 (one) volt, 2 (two) volts, and/or the like. The control signal is the signal that is to be modulated onto the light in the optical domain. The control signal can change over time. For example, the control signal can follow a sine wave, a cosine wave, and/or any other type of wave.

At step 314, the interferometric device splits the first modulated portion of light and the second modulated and phase shifted portion of light (e.g., using a second beam splitter in optical communication with the first optical path and the second optical path) into a third portion of light and a fourth portion of light, respectively. The interferometric device can have two optical outputs that output the third and fourth portions of light, such that the third portion of light travels through the first optical output, and the fourth portion of light travels through the second optical output. At step 316, the interferometric device can detect the third and fourth portions of light. The interferometric device can include one or more detectors to detect the output light. For example, the interferometric device can include a first detector in optical communication with the first optical output and a second detector in optical communication with the second optical output. The interferometric device can detect, via the first detector, the third portion of light, and detecting, via the second detector, the fourth portion of light.

In some embodiments, the detectors are located at a different portion or location on the chip, or at a distant location. For communication purposes, for example, the output intensity of the interferometric FK device can be tied to a bit value that is encoded using a communication protocol. The communication protocol can be, for example, pulse amplitude modulation (e.g., PAM-2, PAM-4, PAM-8, and so on), where the amplitude of the signal encodes the information, or pulse width modulation, where the width of the high-intensity signal encodes the information. Based on the detected intensity of the modulated signals and the chosen protocol, the output current from the detectors can then be fed into a decision circuit to decipher the information that was encoded by the interferometric FK device.

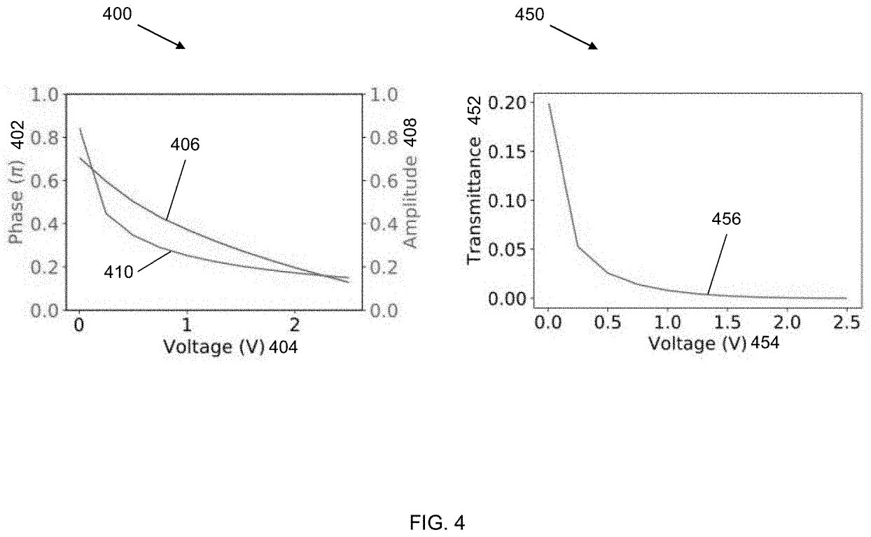

FIG. 4 shows two graphs illustrating the operational characteristics of an interferometric device, according to some embodiments. As described herein, the interferometer can generate an amplitude based on the phase shift between the control voltage and the driving voltage. Graph 400 plots, for an exemplary FK modulator, the phase (it) 402 along the y-axis to the voltage (V) 404 along the x-axis, as shown by line 406. Graph 400 also plots the amplitude 408 along the y-axis to the voltage (V) 404, as shown by line 410. As shown by graph 400, the lines 406 and 410 show how the phase 402 and the amplitude 408, respectively, change depending on the control signal voltage 404.

Graph 450 plots the transmittance 452 along the y-axis to the voltage (V) 454 along the x-axis, as shown by line 456, for an exemplary interferometric device (e.g., as implemented using the techniques described in conjunction with FIGS. 1 and/or 2). Graph 450 shows that the interferometric configuration can achieve arbitrarily close to zero transmittance (maximum extinction) at reasonable voltage values for CMOS chips. Furthermore, as shown by graph 450, the amount of extinction afforded by the interferometric device is higher than that of a single FK modulator for the same amount of voltage applied to the modulators. The interferometric device can thus be used to enhance the extinction of FK modulators.

Various materials can be used with the techniques described herein. Germanium (GE) is an example of a material that readily shows the FK effect because of its pseudo-direct band-gap while being compatible with standard manufacturing practices. In addition, the direct band-gap of Ge (0.8 eV) makes it conducive for FK operation at wavelengths close to 1550 nm which can be of great interest to a wide variety of applications. Based on the particular application, Ge can also be alloyed with silicon to tune the operation wavelength around 1550 nm. If a different wavelength band is desired, Ge can be replaced with other direct or pseudo-direct band-gap materials, such as the III-V materials etc. Therefore, various materials used to achieve the FK effect, such has Ge or others as described herein, should achieve high extinction ratios with low insertion losses as described herein. Using the embodiments shown in FIG. 2, for example, configurations can be designed using a laser as the input light source, one constant voltage source and another voltage source to act as the desired signal voltage. A detector can be used to measure the output and to derive the characteristics such as the extinction ratio and the insertion loss.

It should be appreciated that the techniques described herein can be used in various applications. For example, interferometers can be used in various fields, such as fiber optics, spectroscopy, quantum mechanics, and microfluidics, to name a few non-limiting examples. As an illustrative example, the techniques can be used for high-speed analog photonics, high-speed telecommunications (e.g., including short-haul, mid-haul, and/or long-haul applications), and/or the like.

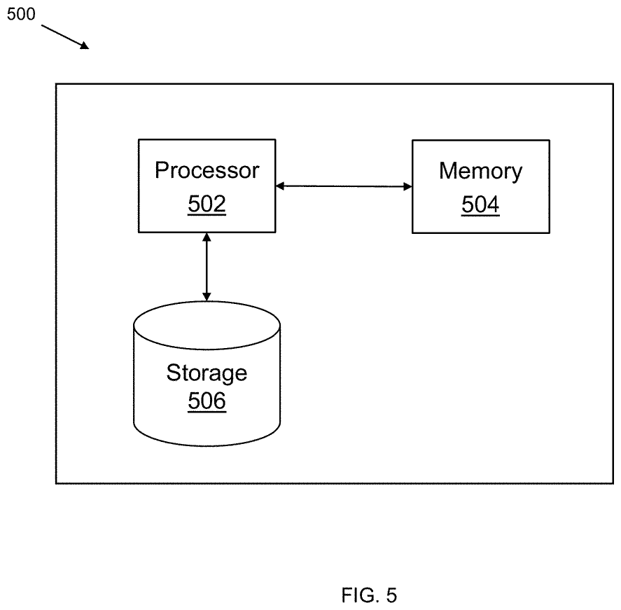

The techniques described herein can be incorporated into various types of circuits and/or computing devices. FIG. 5 shows a block diagram of an example computer system 500 that may be used to implement embodiments of the technology described herein. The computing device 500 may include one or more computer hardware processors 502 and non-transitory computer-readable storage media (e.g., memory 504 and one or more storage devices 506, such as non-volatile storage). The processor(s) 502 may control writing data to and reading data from (1) the memory 504; and (2) the storage device(s) 506. To perform any of the functionality described herein, the processor(s) 502 may execute one or more processor-executable instructions stored in one or more non-transitory computer-readable storage media (e.g., the memory 504), which may serve as non-transitory computer-readable storage media storing processor-executable instructions for execution by the processor(s) 502.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform tasks or implement abstract data types. Typically, the functionality of the program modules may be combined or distributed.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. An apparatus comprising:
an interferometric device comprising a first optical path and a second optical path; and
at least one Franz-Keldysh (FK) modulator disposed in either the first optical path or the second optical path of the interferometric device.

2. The apparatus of claim 1, wherein the interferometric device comprises a Mach-Zehnder interferometer.

3. The apparatus of claim 1, wherein the at least one FK modulator comprises a first FK modulator and a second FK modulator.

4. The apparatus of claim 3, wherein:
the first FK modulator is disposed in the first optical path of the interferometric device; and
the second FK modulator is disposed in the second optical path of the interferometric device.

5. The apparatus of claim 4, wherein:
the first FK modulator comprises a first set of electrodes;
the second FK modulator comprises a second set of electrodes;
a first electrode of the first set of electrodes of the first FK modulator is in electrical communication with a full voltage driving source; and
a second electrode of the second set of electrodes of the second FK modulator is in electrical communication with a control driving source.

6. The apparatus of claim 5, wherein:
a third electrode of the first set of electrodes of the first FK modulator is in electrical communication with a ground; and
a fourth electrode of the second set of electrodes of the second FK modulator is in electrical communication with the ground.

7. The apparatus of claim 5, wherein:
a first phase shifter is disposed in the first optical path;
a second phase shifter is disposed in the second optical path; or both.

8. The apparatus of claim 7, wherein:
The first phase shifter, the second phase shifter, or both, comprises a pi phase shifter.

9. The apparatus of claim 1, wherein the interferometric device comprises:
an optical input, a first optical output, and a second optical output;
a first beam splitter in optical communication with the optical input, the first optical path, and the second optical path; and
a second beam splitter in optical communication with the first optical path, the second optical path, the first optical output, and the second optical output.

10. The apparatus of claim 9, wherein the interferometric device further comprises:
a first detector in optical communication with the first optical output; and
a second detector in optical communication with the second optical output.

11. The apparatus of claim 1, wherein the at least one FK modulator comprises:
a waveguide comprising a proximal end for receiving light, a distal end for emitting light, and an outer perimeter extending between the proximal end and the distal end along an optical path of the waveguide; and
a pair of electrodes disposed on opposite sides of the optical path of the waveguide, such that the pair of electrodes can apply an electric field in a direction across to the optical path.

12. A method, comprising:
receiving, by an interferometric device, input light, wherein:
a first portion of the input light travels along a first optical path of the interferometric device; and
a second portion of the input light travels along a second optical path of the interferometric device; and
modulating, by at least one Franz-Keldysh (FK) modulator disposed in either the first optical path or the second optical path of the interferometric device, an intensity of either the first portion of the input light or the second portion of the input light.

13. The method of claim 12, wherein:
the at least one FK modulator comprises a first FK modulator and a second FK modulator, wherein:
the first FK modulator is disposed in the first optical path of the interferometric device; and
the second FK modulator is disposed in the second optical path of the interferometric device; and
modulating the intensity of the first portion of the input light or the second portion of the input light comprises:
modulating a first intensity of the first portion of the input light traveling along the first optical path to generate a modulated first portion of light; and
modulating a second intensity of the second portion of the input light traveling along the second optical path to generate a modulated second portion of light.

14. The method of claim 13, wherein the method further comprises:
applying a full driving voltage to a first electrode of a first set of electrodes of the first FK modulator; and
applying a control voltage to a second electrode of a second set of electrodes of the second FK modulator.

15. The method of claim 13, further comprising:
shifting, by a first phase shifter disposed in the first optical path, a phase of the modulated first portion of light traveling along the first optical path;
shifting, by a second phase shifter disposed in the second optical path, a phase of the modulated second portion of light traveling along the second optical path; or both.

16. The method of claim 12, wherein:
receiving the input light comprises receiving the input light through an optical input of the interferometric device; and
the method further comprises:
splitting the input light, using a first beam splitter in optical communication with the optical input, the first optical path, and the second optical path, into:
the first portion of the input light that travels along the first optical path; and
the second portion of the input light that travels along the second path.

17. The method of claim 16, further comprising:
splitting the first portion of the input light and the second portion of the input light, using a second beam splitter in optical communication with the first optical path and the second optical path, into:
a third portion of light that travels through a first optical output of the interferometric device; and
a fourth portion of light that travels through a second optical output of the interferometric device.

18. The method of claim 17, further comprising:
detecting, via a first detector in optical communication with the first optical output, the third portion of light; and
detecting, via a second detector in optical communication with the second optical output, the fourth portion of light.

19. The method of claim 12, wherein the light is electromagnetic radiation.

20. The method of claim 19, wherein the electromagnetic radiation is visible light, infrared light, ultraviolet light, x-ray light, or some combination thereof.

21. A method of manufacturing an interferometric device, the method comprising:
forming a first optical path and a second optical path of the interferometric device; and
forming at least one Franz-Keldysh (FK) modulator disposed in either the first optical path or the second optical path of the interferometric device.

22. The method of claim 21, wherein forming the at least one FK modulator comprises:
forming a first FK modulator disposed in the first optical path of the interferometric device; and
forming a second FK modulator disposed in the second optical path of the interferometric device.
